(19) United States
(12) Patent Application Publication
(10) Pub. No.: US 2006/0118418 A1
(43) Pub. Date: Jun. 8, 2006

(54) Electrophoresis gels and buffers and methods of performing electrophoresis

(76) Inventors: Mathoor Sivaram, Newbury, OH (US); John A. Koch, Euclid, OH (US); Milita P. Matousek, Strongsville, OH (US)

Correspondence Address: FOLEY AND LARDNER LLP;SUITE 500, 3000 K STREET NW, WASHINGTON, DC, 20007, US

(21) Appl. No.: 11/180,919

(22) Filed: Jul. 14, 2005

Related U.S. Application Data
(60) Provisional application No. 60/632,346, filed on Dec. 2, 2004.

(51) Int. Cl. B01D 59/42; G01N 27/447

(52) U.S. Cl. 204/468; 204/606

(57) ABSTRACT

The present invention provides electrophoresis gels and buffers for protein or nucleic acid electrophoresis comprising the compound of Formula I:

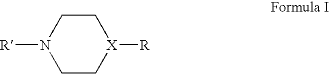

wherein R′ is a C₁-C₆ alkyl substituted with SO₃H and optionally substituted with OH; if X=0, R is a pair of electrons; and if X=N, R is R′ and salts and solvates thereof.. The present invention also provides pre-cast gels and pre-mixed gel solutions comprising the compound of formula I. The present invention further provides methods of performing electrophoresis using the gels and buffers comprising a compound of formula I. The gels and buffers comprising a compound of Formula I offer extended shelf life and good protein and nucleic acid resolution.

### RELATED APPLICATIONS

This application claims priority to provisional patent application No. 60/632,346, filed Dec. 2, 2004, “Electrophoresis Gels and Buffers and Methods of Performing Electrophoresis” to Sivaram et al., which is hereby incorporated by reference in its entirety.

### BACKGROUND OF THE INVENTION

Gel electrophoresis is a common procedure for the separation of biological molecules, such as polypeptides and polynucleotides. In gel electrophoresis, the molecules are separated into bands according to the rate at which an imposed electric field causes them to migrate through a separating gel.

The basic apparatus used in this technique consists of a gel enclosed in a glass tube or sandwiched as a slab between glass or plastic plates. The gel has an open molecular network structure, defining pores which are saturated with an electrically conductive buffered solution of a salt. These pores through the gel are large enough to admit passage of the migrating macromolecules.

The gel is placed in a chamber in contact with one or more buffer solutions which make electrical contact between the gel and the cathode or anode of an electrical power supply. A sample containing the macromolecules, such as polypeptides or polynucleotides, and a tracking dye is placed on the gel. An electric potential is applied to the gel causing the sample macromolecules and tracking dye to migrate toward the bottom of the gel. The electrophoresis is halted before the tracking dye reaches the end of the gel. The locations of the bands of separated macromolecules are then determined. By comparing the distance moved by particular bands in comparison to the tracking dye and macromolecules of known mobility, the mobility of other macromolecules can be determined. The size of the macromolecule can then be calculated.

The rate of migration of macromolecules through the gel depends upon three principle factors: the porosity of the gel; the size and shape of the macromolecule; and the charge density of the macromolecule. It is critical to an effective electrophoresis system that these three factors be precisely controlled and reproducible from gel to gel and from sample to sample. However, maintaining uniformity between gels is difficult because each of these factors is sensitive to many variables in the chemistry of the gel system.

Polyacrylamide gels are commonly used for electrophoresis. Polyacrylamide gel electrophoresis or PAGE is popular because the gels are optically transparent, electrically neutral and can be made with a range of pore sizes. The porosity of a polyacrylamide gel is in part defined by the total percentage of acrylamide monomer plus crosslinker monomer (“% T”) it contains. The greater the concentration, the less space there is between strands of the polyacrylamide matrix and hence the smaller the pores through the gel. For example, an 8% polyacrylamide gel has larger pores than a 12% polyacrylamide gel. An 8% polyacrylamide gel consequently permits faster migration of macromolecules with a given shape, size and charge density. When smaller macromolecules are to be separated, it is generally preferable to use a gel with a smaller pore size such as a 20% gel. Conversely, for separation of larger macromolecules, a gel with a larger pore size is often used, such as an 8% gel.

Pore size is also dependent upon the amount of crosslinker used to polymerize the gel. Several factors may cause undesirable variation in the pore size of gels. Pore size can be increased by incomplete gel polymerization during manufacture. Hydrolysis of the polyacrylamide after polymerization can create fixed negative charges and break down the crosslinks in the gel, which will degrade the separation and increase the pore size. An ideal gel system should have a reproducible pore size and no fixed charge (or at least a constant amount) and should be resistant to change in chemical characteristics or the pore size due to hydrolysis.

The size and shape of a macromolecule is also a determining factor in how it responds to electrophoresis; the smaller and more compact the macromolecule the easier it will be for the macromolecule to move through the pores of a given gel. Given a constant charge density, the rate of migration of a macromolecule is inversely proportional to the logarithm of its size.

For accurate and reproducible electrophoresis, a given type of macromolecule should preferably take on a single form in the gel. One difficulty with maintaining uniformity of the shape of proteins during gel electrophoresis is that disulfide bonds can be formed by oxidation of pairs of cysteine amino acids. Different oxidized forms of the protein then have different shapes and, therefore, migrate through the gel run with slightly different mobilities (usually faster than a completely reduced protein, since the maximum stokes radius and minimum mobility should occur with a completely unfolded form). A heterogeneous mixture of forms leads to apparent band broadening. In order to prevent the formation of disulfide bonds, a reducing agent such as dithiothreitol (DTT) is usually added to the samples to be run. Additionally, the shape of some macromolecules, such as DNA and RNA, is dependent on temperature. In order to permit electrophoresis on temperature-dependent molecules in their desired form, separations are done at a controlled temperature.

The charge density of the migrating molecule is the third factor affecting its rate of migration through the gel—the higher the charge density, the more force will be imposed by the electric field upon the macromolecule and the faster the migration rate subject to the limits of size and shape. In SDS-PAGE electrophoresis, the charge density of the macromolecules is controlled by adding sodium dodecyl sulfate (SDS) to the system. SDS molecules associate with the macromolecules and impart a uniform charge density to them, substantially negating the effects of any innate molecular charge. Unlike proteins, the native charge density of some macromolecules, such as DNA and RNA, is generally constant, due to the uniform occurrence of phosphate groups. Thus, charge density is not a significant problem in electrophoresis of macromolecules such as DNA and RNA. On the other hand, agents, such as SDS, are routinely used when performing electrophoresis on polypeptide samples.

In general, there are two types of buffer systems in electrophoresis, continuous and discontinuous. A continuous system has only a single separating gel and uses the same buffer in the tanks and the gel. In a discontinuous system, a non-restrictive large pore gel, called a stacking gel, is layered on top of a separating gel called a resolving gel. Each gel is made with a different buffer, and the tank buffers are different from the gel buffers. The resolution obtained in a discontinuous system is generally much greater than that obtained with a continuous system.

SDS-PAGE gels are usually poured and run at basic pH. The most common PAGE buffer system employed for the separation of proteins is a discontinuous system developed by Ornstein and modified for use with SDS by Laemmli. Laemmli, U. K. (1970) Nature 227, 680-686. The Laemmli buffer system, has a separating gel consisting of 0.375 M tris (hydroxy methyl) amino-methane (Tris), titrated to pH 8.8 with HCl. The stacking gel consists of 0.125 M Tris, titrated to pH 6.8. The anode and cathode running buffers contain 0.024 M Tris, 0.192 M glycine, and 0.1% SDS.

An alternative discontinuous buffer system is disclosed by Schaegger and von Jagow. Schaegger, H. and von Jagow, G., Anal. Biochem. 1987, 166, 368-379, which is herein incorporated by reference in its entirety. The stacking gel contains 0.75 M Tris, titrated to pH 8.45 with HCl. The separating gel contains 0.9 M Tris, titrated to pH 8.45 with HCl. The cathode buffer contains 0.1 M Tris, 0.1 M N-tris(hydroxymethyl)methylglycine (tricine) and 0.1% SDS. The anode buffer contains 0.2 M Tris, titrated to pH 8.9 with HCl.

Current electrophoresis systems suffer from a number of drawbacks. In both the SDS-PAGE and Schaegger systems, Tris is the “common ion” which is present in the gel and in the anode and cathode buffers. The resulting pH of the buffer system is relatively basic, causing degradation of the gel matrix and reactivity with protein or other samples, among other negative effects. The preparation time for these discontinuous buffer systems is at least 30 minutes, due to the necessity for preparing a stacking gel and a separating gel. This preparation time can be a significant factor, especially when a large number of gels are being prepared. Other buffer systems use a gradient gel where the polymer concentration varies between anode and cathode. These gradient systems can offer superior resolution of a wide range of samples, but with the added cost of having to prepare a cumbersome gradient gel.

In the Laemmli system, the pH of the trailing phase in the stacking gel is about 8.9. In the separating gel, the trailing phase pH is about 9.7. At these relatively high pH levels, (1) primary amino groups of proteins react readily with unpolymerized acrylamide, (2) thiol groups are more subject to oxidation to disulfides or reaction with unpolymerized polyacrylamide than at neutral pH, and (3) acrylamide itself is subject to hydrolysis. Thus, this system suffers from unpredictability.

Traditionally, agarose gels have also been used to resolve various macromolecule samples, including proteins. They are an attractive option, because they are easy to pour at concentrations varying from 0.5% to 4%, in different configurations, and with up to 200 samples per gel. However, agarose gels have not typically been able to provide good resolution of some types of macromolecules through electrophoresis, including proteins.

The need for uniformity and predictability is magnified in pre-cast electrophoresis gels which are manufactured by an outside vendor and then shipped to the laboratory where the electrophoresis will be performed. Pre-cast gels must control the properties discussed above and they must be able to maintain this control throughout shipping and storage. The shelf life of many pre-cast gels is limited by the potential for hydrolysis of acrylamide and/or buffer constitution during storage at the high pH of the gel buffer. Typically, current pre-cast gels have a shelf life of only about 1-2 months. Attempts have been made to alter the pH to improve shelf life with only limited success.

Thus, current protein and nucleic acid electrophoresis systems suffer from a number of limitations. Improved gels and buffers are needed that provide gels that can be prepared quickly, have good resolution, and are stable for a long period of time.

### SUMMARY OF THE INVENTION

In one embodiment, the present invention provides an electrophoresis gel composition comprising (a) a polymer and (b) at least 25 mM of at least one compound of Formula I: 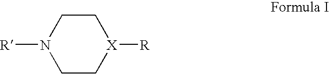
wherein R′ is a C₁-C₆ alkyl substituted with SO₃H and optionally substituted with OH; if X=0, R is a pair of electrons; and if X=N, R is R′ and salts and solvates thereof. In some embodiments, the gel is substantially free of formaldehyde.

In another embodiment, the present invention provides a pre-mixed solution for forming a gel comprising: (a) a compound that can be polymerized to form an electrophoresis gel and (b) and (b) at least 25 mM of at least one compound of Formula I: 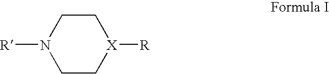
wherein R′ is a C₁-C₆ alkyl substituted with SO₃H and optionally substituted with OH; if X=0, R is a pair of electrons; and if X=N, R is R′ and salts and solvates thereof. In some embodiments, the gel is substantially free of formaldehyde.

In yet another embodiment, the present invention provides a method of separating proteins or nucleic acids using electrophoresis comprising (a) providing an electrophoresis gel comprising a polymer and at least 25 mM of at least one compound of Formula I: 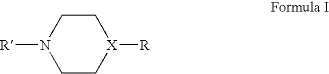
wherein R′ is a C₁-C₆ alkyl substituted with SO₃H and optionally substituted with OH;
if X=0, R is a pair of electrons; and if X=N, R is R′ and salts and solvates thereof; and (b) separating proteins or nucleic acids placed on the gel using electrophoresis.

In still another embodiment, the present invention provides a kit for protein or nucleic acid electrophoresis comprising an electrophoresis gel comprising at least 25 mM of at least one compound of Formula I: 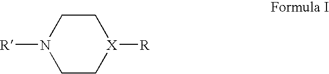
wherein R′ is a C₁-C₆ alkyl substituted with SO₃H and optionally substituted with OH;
if X=0, R is a pair of electrons; and if X=N, R is R′ and salts and solvates thereof.

A kit for protein or nucleic acid electrophoresis comprising a pre-mixed solution comprising a compound that can be polymerized to form an electrophoresis gel and at least 25 mM of at least one compound of Formula I: 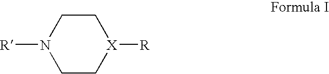
wherein R′ is a C₁-C₆ alkyl substituted with SO₃H and optionally substituted with OH;
if X=0, R is a pair of electrons; and if X=N, R is R′ and salts and solvates thereof.

### BRIEF DESCRIPTION OF THE DRAWINGS

FIG. 1 shows a schematic of the relationship between gel concentration, the concentration of a compound of Formula I, and protein mobility.

FIG. 2 shows a sample of stained proteins separated by electrophoresis with a 10% polyacrylamide gel prepared with 333 mM MOPS and 0.6% SDS. This figure shows the lower range of molecular weights that were separated in this experiment, ranging from 14.4 kD to 97.4 kD.

FIG. 3 shows the results of electrophoresis using a 100/9 polyacrylamide gel comprising MOPS alongside the results of electrophoresis using a 12% Laemmli gel. The 10% polyacrylamide gel comprising MOPS resolved proteins ranging from 3.5 kD to 212 kD.

FIG. 4 shows two samples of stained proteins separated by electrophoresis. Sample A was separated using a 10% polyacrylamide gel prepared with 333 mM MOPS and 0.6% SDS and Sample B was separated using a 10% polyacrylamide gel prepared with 111 mM MOPS and 0.2% SDS. The range of separated proteins shown in the samples range from 14.4 kD to 212.0 kD.

FIG. 5 shows two samples of stained proteins separated by electrophoresis. Sample A was separated using a 4% agarose gel comprising MOPS, resolving proteins ranging from 212 kD to 14.4 kD. Sample B was separated using a 2% agarose gel comprising MOPS, resolving proteins ranging from 200 kD to 1000 kD.

FIG. 6 shows different concentrations of polyacrylamide gels comprising 333 mM MOPS. FIG. 6A shows a 5% polyacrylamide gel, FIG. 6B shows a 7.5% polyacrylamide gel, FIG. 6C shows a 10% polyacrylamide gel, FIG. 6D shows a 12.5% polyacrylamide gel, and FIG. 6E shows a 15% polyacrylamide gel.

FIG. 7 shows a 10% polyacrlyamide gel comprising 333 mM MOPS to a standard 12% polyacrylamide gel.

FIG. 8 shows a comparison DNA fragment migration on a 6% acrylamide gel comprising 333 mM MOPS and a 6% acrylamide gel comprising 50 mM MOPS.

FIG. 9 shows protein migration on a 10% polyacrylamide gel comprising 0.3M MOPSO and 0.3 M POPSO.

FIG. 10 shows migration of protein molecular weight markers and cross-linked myosin on a 2% agarose gel comprising 0.1% SDS and 50 mM MOPS at pH 7.7. Lane 1 shows the molecular weight markers and lane 2 shows cross-linked myosin.

### DETAILED DESCRIPTION OF THE PREFERRED EMBODIMENTS

Unless otherwise specified, “a” or “an” means “one or more.” “Protein” refers to any amino acid oligomer modified, by glycosylation or phoshorylation for example, or unmodified including shorter length polypeptides and larger proteins or protein complexes. “Nucleic acid” refers to any nucleic acid, such as DNA and RNA, including any modified nucleic acid. A specified concentration of a compound of Formula I may be reached by adding different compounds of formula I. For example, a specified concentration of at least 300 mM of a compound of formula I can be achieved by a composition comprising 100 mM MOPS and 200 mM MOPSO.

The present invention provides a protein and nucleic acid electrophoresis gels and buffers comprising at least one compound of Formula I:

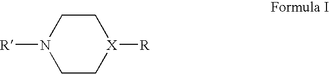

wherein R′ is a C₁-C₆ alkyl substituted with SO₃H and optionally substituted with OH;
if X=0, R is a pair of electrons; and if X=N, R is R′ and salts and solvates thereof.

Examples of suitable compounds of Formula I include, but are not limited to, 3-(N-morpholino) propanesulfonic acid (MOPS), 2-Hydroxy-3-morpholinopropanesulfonic acid (MOPSO), Piperazine-1,4-bis(2-ethanesulfonic acid) (PIPES), and Piperazine-1,4-bis(2-hydroxy-3-propanesulfonic acid), dehydrate (POPSO) as shown below.

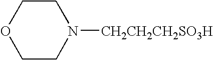

3-Morpholinopropanesulfonic acid (MOPS)

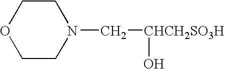

2-Hydroxy-3-morpholinopropanesulfonic acid (MOPSO)

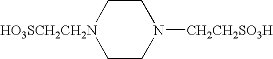

Piperazine-1,4-bis(2-ethanesulfonic acid) (PIPES)

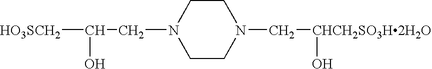

Piperazine-1,4-bis(2-hydroxy-3-propanesulfonic acid), dihydrate (POPSO)

The gels and buffers comprising a compound of Formula I offer a number of advantages. The gels do not require a stacking gel for use in electrophoresis of some macromolecules, including proteins, thus significantly reducing preparation time and cost. The gels comprising a compound of Formula I also possess strong protein and nucleic acid resolving characteristics. Moreover, the gels comprising a compound of Formula I offer increased uniformity and predictability. Pre-cast gels and pre-mixed gel solutions comprising a compound of Formula I are stable for up to one year at room temperature compared to only one or two months with traditional gels. The neutral or near neutral pH of the gel comprising compound of Formula I reduces hydrolysis of the gel polymer and breakdown of the buffer constituents, and the protein samples are much less likely to react with the gel polymers at neutral pH. In some embodiments, the gels and buffers of the present invention may have a pH ranging from 7.0 to 9, in some embodiments, 7.0 to 8, and in some embodiments 7.5 to 8. The gel and buffer system comprising a compound of Formula I can be used to resolve a wide range of proteins and nucleic acids without a gradient gel.

Without being bound by any possible explanation for the effects of gels and buffers comprising the compound of Formula I, one possible explanations is that the compound of Formula I may be binding to or interfering with the protein-surfactant complex and thus affecting the net charge of the complex and migration in an electric field. It is also possible that the compound of Formula I may be displacing loosely bound surfactant from proteins, creating a true protein-surfactant complex. However, it is also possible that the effects of the compound of Formula I are due to one or more other mechanisms, and the invention should not be limited based on any explanation.

a. Compositions Comprising a Compound of Formula I

Any suitable compound of Formula I can be used to prepare the gels and buffers of the present invention. In some embodiments, the C₁-C₆ alkyl chain is a methyl and in some embodiments the alkyl chain is an ethyl. In some embodiments, at least one SO₃H is substituted at the terminal end of the alkyl chain. In one embodiment, MOPS is used. Other exemplary compounds of Formula I include, but are not limited to, MOPSO, PIPES, and POPSO.

The gels and buffers of the present invention also preferably contain at least one surfactant. Any suitable surfactant can be used. Examples of suitable surfactants include SDS, Triton X-100, fand TWEEN. For example, SDS can be present in a concentration of at least 0.1%, at least 0.2%, at least 0.4%, or at least 0.6%. SDS is often used as a surfactant to give proteins a uniform negative charge when performing gel electrophoresis.

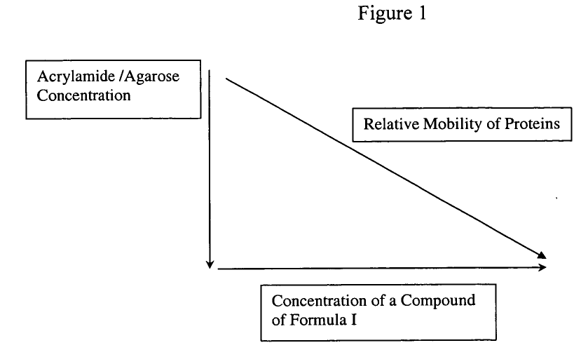

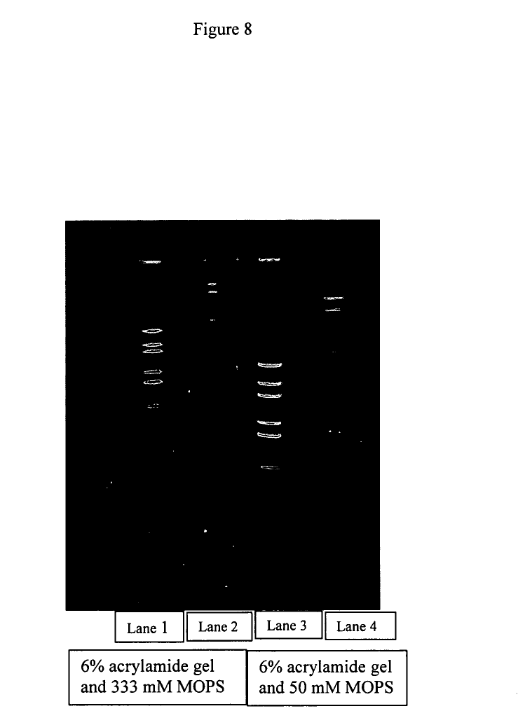

A compound of Formula I can be included in any number of components of the present invention. Preferably, the electrophoresis gel itself is made using a compound of Formula I. The addition of a compound of Formula I to the electrophoresis gel typically improves the shelf life of gels allowing greater uniformity and predictability. The gel comprising a compound of Formula I surprisingly improves protein and nucleic acid resolution, especially with agarose gels. This is rather unexpected, because the resolution of proteins on gels is generally considered to be solely dependent on the gel concentration and not on the nature of the buffer component of the gel. However, an increased concentration of a compound of Formula I in the gel has been found to typically decrease the mobility of proteins and nucleic acids as shown in FIGS. 1 and 8. In some embodiments, the gel and/or the running buffer comprises a compound of Formula I and is also substantially free of formaldehyde.

The running buffer can also be made using a compound of Formula I. In some embodiments, the separating gel contains a higher percentage of a compound of Formula I than the running buffer. In some embodiments, only the gel contains a compound of Formula I. The concentrations of the compound of Formula I can be the same or different in the gel and buffer components.

A compound of Formula I is preferably present in free acid form but can also be present in any other form, such as a titrated form using ethylene diamine tetra-acetic acid (EDTA). Any suitable concentration of a compound of Formula I can be used. In some embodiments, the gel will comprise at least 25 mM of a compound of Formula I, in some embodiments at least 50 mM of a compound of Formula I, in some embodiments at least 100 mM of a compound of Formula I, in some embodiments at least 300 mM of a compound of Formula I, and in some embodiments at least 500 mM of a compound of Formula I. As noted in FIG. 1, increased concentrations of a compound of Formula I typically decrease protein mobility. Nucleic acids mobility is also decreased in the same manner as illustrated in FIG. 8. Thus, one of ordinary skill in the art can readily select a desired concentration based on the proteins or nucleic acids to be separated. Typically, higher concentrations of a compound of Formula I can be used to resolve lower molecular weight proteins and nucleic acids. A compound of Formula I can be present in the running buffer at any concentration, such as the concentrations listed above, but is typically present in concentrations less than in the gel. For example, the running buffer can comprise at least 50 mM a compound of Formula I and in some embodiments at least 100 mM a compound of Formula I, while the gel can comprise at least 300 mM a compound of Formula I.

The gel comprising a compound of Formula I can be any suitable electrophoresis gel. For example, the gel can be a polyacrylamide gel or an agarose gel. Polyacrylamide gels are made using techniques well known in the art. Polyacrylamide gels for protein separation typically contain from 4% to 15% acrylamide. In some embodiments, the gel comprises polyacrylamide in concentrations, such as, at least 4.0%, at least 5.0%, at least 7.5%, at least 10.0%, at least 12.5%, and in some embodiments such as at least 15.0%. In general, acrylamide monomers are polymerized, which occurs spontaneously in the absence of oxygen, to form gels. Typical catalysts include ammonium persulfate (10%, for example) and N,N′-tetramethylenediamine (TEMED). Polyacrylamide gels also include a cross-linker, because polyacrylamide alone is a linear polymer. Any suitable cross-linker may be used, such as N,N′-methylene bis-acrylamide (bis). Bis is typically used in a ratio of ranging from 19:1 to 38:1 acrylamide to bis. For example, the acrylamide to bis ratio may be 25:1 or greater or 37.5:1 or greater. Agarose can also be used to form an electrophoresis gel comprising a compound of Formula I. Typically, the agarose gels can contain a lower concentration of a compound of Formula I compared to polyacrylamide gels. For example, agarose gels can contain at least 25 mM or at least 50 mM of a compound of Formula I. Agarose gels can be prepared by melting agarose in a warm aqueous solution and allowing the solution to cool to form a gel. In some embodiments, the gel comprises agarose in concentrations of at least 2%, at least 4%, or at least 8%. For example, gels can comprise at least 2% agarose or at least 3% agarose. In some embodiments, the gels comprise some combination of polyacrylamide and agarose along with a compound of Formula I.

Additional ingredients are often included in electrophoresis gels, such as buffers and other reagents. The present invention includes at least one compound of Formula I, but and other additional buffer can also be used. Tris is a common buffer used in electrophoresis gels. For example, electrophoresis gels can include Tris-HCl, Tris-glycine, and Tris-acetate. The pH can be adjusted to a desired level depending on the particular application. Typical pH values range from 7 to 9.5. For example, in some embodiments, the pH can range from 7 to 7.5, in some embodiments, 7.5 to 8, and in some embodiments from 8 to 8.5. Examples of other suitable ingredients used in electrophoresis gels include urea, boric acid, or EDTA.

The gels of the present invention can be made directly by the end-user using buffers comprising a compound of Formula I or the gels can be pre-cast and delivered to the end-user. The use of pre-cast gels by end-users drastically reduces the preparation time for electrophoresis. The pre-cast gels comprising a compound of Formula I also have the benefit of being stable for long periods of time. This provides uniformity and predictability.

The present invention also provides a pre-mixed solution comprising a compound of Formula I. This pre-mixed solution can be stored and later prepared as a gel. These solutions can contain ingredients as described herein in the amounts described herein. The pre-mixed solutions comprising a compound of Formula I can also be prepared as concentrated solutions. For example, pre-mixed solutions concentrated to at least 20×, at least 10×, or at least 5× can be prepared.

In some embodiments of this invention, the pre-mixed solution comprises a compound of Formula I and a gelling agent, such as acrylamide and/or agarose. The gelling agent or agents can be included in any suitable concentration. For example, the gel can comprise polyacrylamide in concentrations, such as, at least 4.0%, at least 5.0%, at least 7.5%, at least 10.0%, at least 12.5%, and in some embodiments such as at least 15.0%. In other embodiments, the gel can comprise agarose in concentrations of at least 2% or at least 4%. The pre-mixed solutions can further comprise surfactants, such as SDS, Tritong X-100, and TWEEN. These surfactants can be present in any suitable concentration, such as the concentrations described herein. In addition, the pre-mixed solution can contain any suitable additional ingredients. Suitable additional ingredients include, but are not limited to, those described herein. The pH can be adjusted to a desired level depending on the particular application. Typical pH values range from 7 to 9.5. For example, in some embodiments, the pH can range from 7 to 7.5, in some embodiments, 7.5 to 8, and in some embodiments from 8 to 8.5. In some embodiments of this invention, the pre-mixed solution comprises a compound of Formula I in concentrations such as at least 4%, at least 5%, at least 7.5%, at least 10%, at least 12.5% or at least 15%.

The present invention also provides a kit comprising a pre-mixed gel solution comprising a compound of Formula I and/or a pre-cast gel comprising a compound of Formula I. The concentration of a compound of Formula I can be any suitable concentration, such as those concentrations described herein. The kit can also include additional components, such as instructions. The instructions may include a description of how to use or prepare a gel containing a compound of Formula I for use in protein or nucleic acid electrophoresis. The instructions may also include a description of how concentrations of a compound of Formula I can be adjusted to alter protein or nucleic acid mobility as shown in FIG. 1. The kit can also include components, such as buffers, other reagents, and weight markers. Examples of components that can be included in the kit include, but are not limited to those described herein.

b. Methods of Using a compound of Formula I Gels

In another embodiment of this invention, a gel comprising a compound of Formula I is used for electrophoresis, either for proteins or nucleic acids. One advantage of the present invention is that the gel comprising a compound of Formula I can be used alone without the aid of a stacking gel. This benefit reduces the materials needed to perform protein or nucleic acid electrophoresis and thus the cost. In addition, the gels comprising a compound of Formula I exhibit good protein and nucleic acid resolution. The gels are also stable allowing gels to be prepared in advance and used later with good uniformity and predictability.

Gels comprising a compound of Formula I can be used for any type of gel electrophoresis. For example, the gels comprising a compound of Formula I can be used to form slab gels, such as used in horizontal electrophoresis, or used in capillary electrophoresis. The gels comprising a compound of Formula I can be configured for use in high throughput protein separations. Although a stacking gel is not needed when performing electrophoresis on gels comprising a compound of Formula I, a stacking gel can still be used, if desired. Electrophoresis techniques are known in the art and can be readily adapted by one of ordinary skill in the art for use with gels comprising a compound of Formula I.

Electrophoresis can be performed using gels comprising a compound of Formula I such as those described herein. In one embodiment, the present invention provides a method of performing protein or nucleic acid electrophoresis comprising providing a gel comprising a compound of Formula I and performing electrophoresis to separate a protein or nucleic acid sample loaded on the gel. In other embodiments, the gel will comprise at least 25 mM a compound of Formula I, in some embodiments at least 50 mM a compound of Formula I, in some embodiments at least 100 mM a compound of Formula I, in some embodiments at least 300 mM a compound of Formula I, and in some embodiments at least 500 mM a compound of Formula I. A compound of Formula I can be present in the running buffer at any concentration, such as the concentrations listed above, but is typically present in concentrations less than in the gel. For example, the running buffer can comprise 50 mM a compound of Formula I and in some embodiments at least 100 mM a compound of Formula I. However, in some embodiments, the running buffer can be substantially free of a compound of Formula I. Preferably, the gel and/or running buffer further comprise a surfactant, such as SDS. Suitable surfactant concentrations include those concentrations described herein. In addition, concentrations of surfactants can be readily determined by one of ordinary skill in the art based on the specific application.

In some embodiments, the gel comprising a compound of Formula I can be any suitable gel, such as the acrylamide gels described herein. The gel can also be an agarose gel, such as the agarose gels described herein. Agarose gels can be easily prepared and configured to accept a large number of samples. Although resolution has typically been poor, agarose gels comprising a compound of Formula I typically offer improved resolution.

In some embodiments of the present invention, a gel comprising a compound of Formula I can be used for high throughput electrophoresis. The ease of preparation, predictability, stability, and good resolution make the gels and buffers of the present invention ideal for high throughput protein or nucleic acid electrophoresis. High throughput electrophoresis is commonly used in drug screening and other applications. In one embodiment of this invention, more than 200 samples can be separated using a single gel system. In another embodiment, more than 250 samples can be separated using a single gel system. In another embodiment of the present invention, more than 1,000 samples can be separated using as few as 4 gel systems. In another embodiment of this invention, more than 5,000 samples may be separated using as few as 20 gel systems. This is a great benefit when the time and cost of preparing of gel systems is viewed in light of the need to process many samples in a given time frame.

In another embodiment of this invention, a gel comprising a compound of Formula I may be used to carry out two-dimensional gel electrophoresis. Two-dimensional gel electrophoresis separates proteins in two steps, based on two independent properties: (1) the first-dimension is isoelectric focusing (IEF), which separates proteins according to their isoelectric points (pI); and (2) the second-dimension is SDS-polyacrylamide gel electrophoresis (SDS-PAGE), which separates proteins according to their molecular weights (MW). In this way, complex mixtures of thousands of different proteins can be resolved and the relative amount of each protein can be determined. The procedure involves placing the sample in gel with a pH gradient, and applying a potential difference across it. In the electrical field, the protein migrates a long the pH gradient, until it carries no overall charge. This location of the protein in the gel constitutes the apparent pI of the protein. The second step is performed in slab SDS-PAGE.

The gels and buffers of the present invention can be used in place of traditional SDS-PAGE gels. The ease of preparation, predictability, stability, and good resolution make the gels and buffers of the present invention ideal for two-dimensional gel electrophoresis. In one embodiment, a gel comprising at least 50 mM a compound of Formula I may be used to carry out two-dimensional gel electrophoresis. In another embodiment, a gel comprising at least 25 mM a compound of Formula I may be used to carry out two-dimensional gel electrophoresis. In yet another embodiment, a gel comprising at least 50 mM of a compound of Formula I may be used to carry out two-dimensional gel electrophoresis. In still other embodiments, a gel comprising at least 100 mM, 200 mM, or at least 300 mM of a compound of Formula I may be used to carry out two-dimensional gel electrophoresis.

### EXAMPLE 1

### Preparation of Gel and Electrophoresis Method

A pre-mixed solution was prepared with a 7.5% polyacrylamide gel, 333 mM MOPS, 0.667% SDS, 0.2% EDTA and Tris base (sufficient to bring the pH to 7.0). The running buffer was made up of 50 mM MOPS, Tris (sufficient to bring the pH to 7.7) 0.1% SDS and 0.03% EDTA. 10 mL of the pre-mixed solution was mixed with 6 ul of TEMED and 60 ul of freshly made 10% APS, and the solution was mixed and poured immediately. A comb was inserted and the gel was allowed to polymerize for at least 20 minutes. The running buffer was applied to the anode and cathode chambers and test samples were added to the buffer and heated to 95-100 degrees C. for 5 minutes. 10-15 ul of the sample was applied to each well. A 200 volt potential was applied for about one hour until the dye reached the bottom of the gel. The gel was stained for proteins using 0.1% coomassie in 50% methanol/10% acetic acid solution for 15 minutes followed by 12.5% methanol/2.5% acetic acid solution for 30 minutes.

### EXAMPLE 2

### SDS-PAGE Gel Comprising MOPS

A 10% polyacrylamide gel was prepared with 333 mM MOPS and 0.6% SDS (pH 7.7) in the separating gel buffer, as described in Example 1. Electrophoresis was performed on a protein sample with molecular weights ranging from 14.4 kD to 97.4 kD, as described in Example 1. The running buffer used was also a 333 mM MOPS and 0.6% SDS (pH 7.7) buffer.

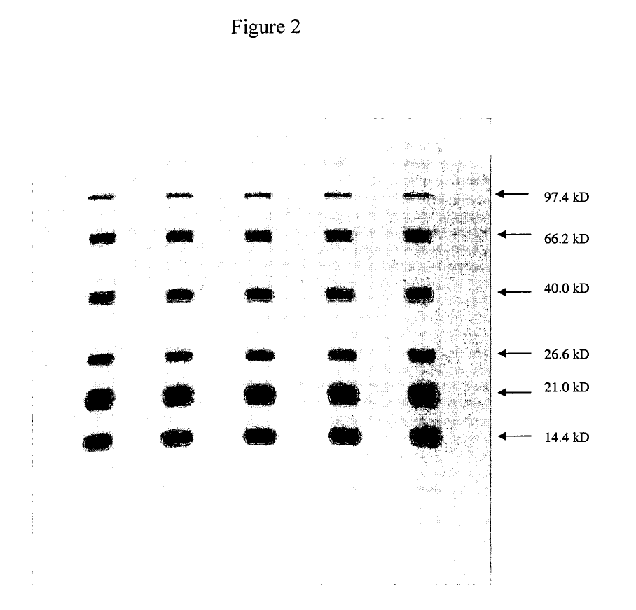

The results are shown in FIG. 2. The figure shows the fine resolution of all proteins in general. In addition, some of the low molecular weight proteins, especially in the range of 14.4 kD to 26.6 kD, migrated slower and with superior resolution compared to that of standard Laemmli gels that did not contain MOPS.

This result is rather unexpected since the resolution of proteins on acrylamide gels is generally considered to be solely dependent on polyacrylamide concentration and not on the nature of the buffer component.

### EXAMPLE 3

### Pre-Mixed Gel Solution Comprising MOPS

A pre-mixed gel solution containing 10% acrylamide, 333 mM MOPS and 0.6% SDS was prepared, and a gel was prepared using this pre-mixed solution. The characteristics of the gel comprising MOPS were compared to that of standard Laemmli gel (12% acrylamide) system by using the gels to perform electrophoresis on identical samples. The composition of the samples is shown below in Table 1.

TABLE 1

| Protein | MW (Daltons) |
|---|---|
| Myosin | 212000 |
| Beta-Galactosidase | 116000 |
| Phosphorylase-B | 97400 |
| Albumin | 66200 |
| Ovalbumin | 40000 |
| Aldolase | 38000 |
| Carbonic Anhydrase | 31000 |
| Triose Phosphate Isomerase | 26600 |
| Trypsin Inhibitor | 21000 |
| Myoglobin | 17000 |
| Lysozyme | 14400 |
| Alpha-Lactalbumin | 14200 |
| Aprotinin | 6500 |
| Insulin B-Oxidized | 3500 |

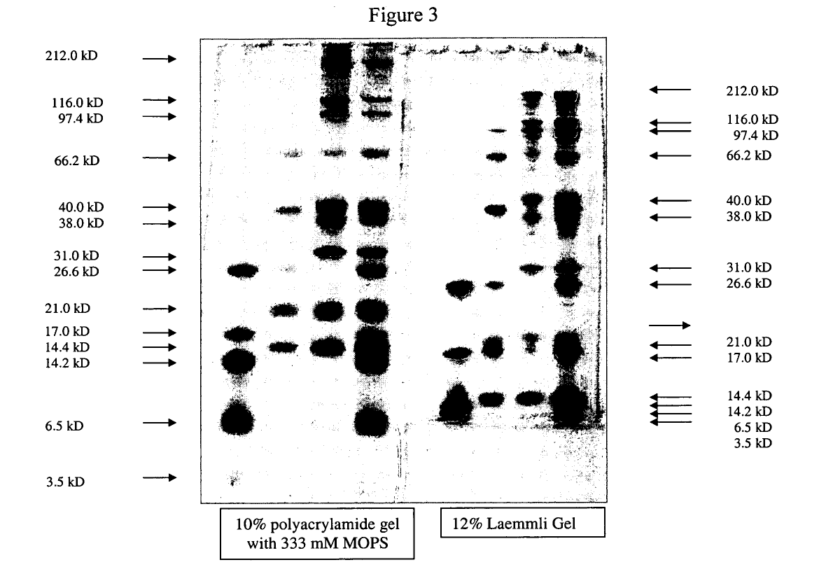

The results are shown in FIG. 3 below. The figure indicates that the gel comprising MOPS provided superior protein resolution compared to the standard Laemmli gel.

### EXAMPLE 4

### Comparison of Gels Containing MOPS in Different Concentrations

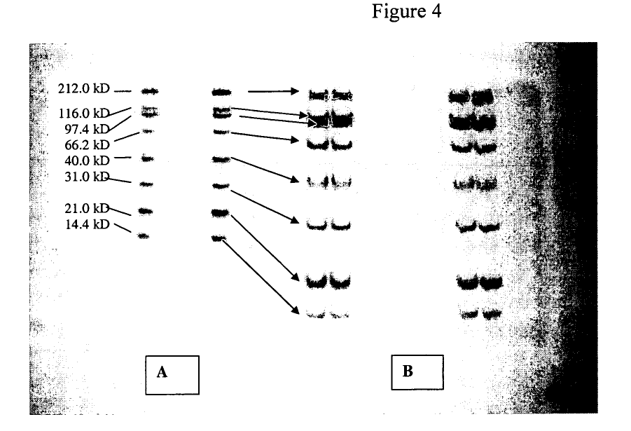

Acrylamide gels were prepared to determine the effects of different MOPS concentrations. Specifically, one gel was prepared with a buffer containing 333 mM MOPS and 0.6% SDS, and another gel was prepared using 111 mM MOPS and 0.2% SDS. The same sample was loaded onto each gel and electrophoresis was performed using 50 mM MOPS at pH 7.7 and 0.1% SDS as the running buffer. The results are shown in FIG. 4. The results show that the gel made with 333 mM MOPS offers superior resolution of the protein sample compared to the gel made with 111 mM MOPS.

### EXAMPLE 5

### Agarose Gels Comprising MOPS

Agarose gels comprising MOPS were made using a buffer comprising 50 mM MOPS and 0.1% SDS at a pH of 7.7. A 2% agarose gel was prepared by mixing 0.5 gm in 23.75 ml of water. The solution was heated in a microwave oven until all of the agarose had melted. A 20× MOPS running buffer was added to a 1× concentration of the hot agarose. The solution was mixed and poured into a horizontal casting unit. The gel was allowed to solidify, and then protein samples were applied onto the gel. A 100 volt potential was applied to the gel until the tracking dye approached the bottom of the gel. The agarose was soaked and stained with 0.05% Coomassie R-250 dissolved in 50% methanol and 10% acetic acid and destained with 50% methanol and 10% acetic acid. A 4% agarose gel was prepared in the same way.

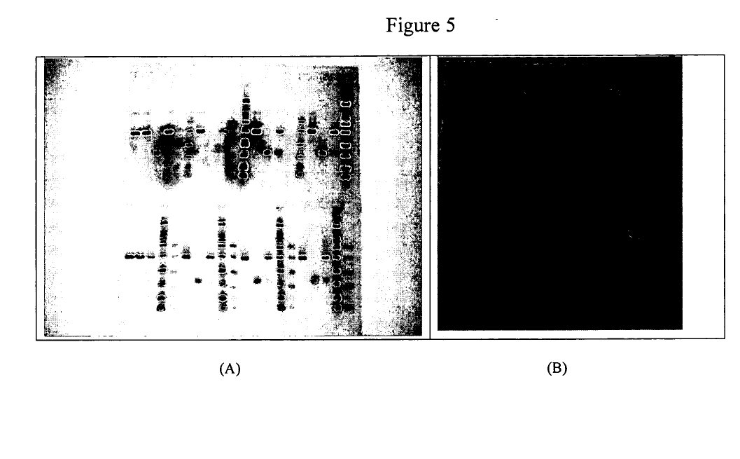

Strong resolution of protein samples was observed as shown in FIG. 5. The left column shows the 4% agarose gel, and the right column shows the 2% agarose gel. The results show that the 4% agarose gel resolved the proteins ranging in weight from 212 kD to 14.4 kD similar to that of a 10% acrylamide gel. The 2% agarose gel resolved proteins above 200 kD and up to 1000 kD in size. This is surprising, because traditional agarose gels have poor resolution. The gels comprising MOPS demonstrate improved resolution.

### EXAMPLE 6

### Comparison of Different MOPS Comprising Gels

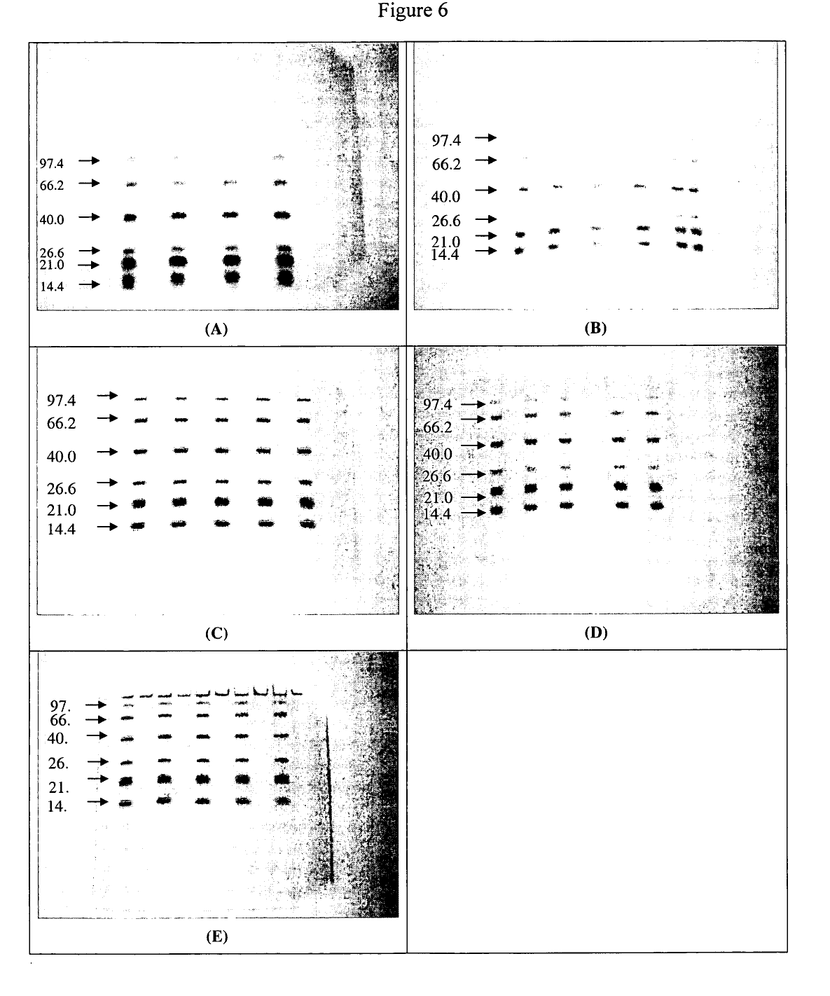

FIG. 6 shows different concentrations of polyacrylamide gels comprising 333 mM MOPS. The gels were prepared as in Example 1. FIG. 6A shows a 5% polyacrylamide gel, FIG. 6B shows a 7.5% polyacrylamide gel, FIG. 6C shows a 10% polyacrylamide gel, FIG. 6D shows a 12.5% polyacrylamide gel, and FIG. 6E shows a 15% polyacrylamide gel. The proteins in the sample tested are shown below in Table 2.

TABLE 2

| Protein | MW (Daltons) |
|---|---|
| Phosphorylase-B | 97400 |
| Bovine Serum Albumin | 66200 |
| Ovalbumin | 40000 |
| Triose Phosphate.Isomerase | 26600 |
| Trypsin Inhibitor | 21000 |
| Lysozyme | 14400 |

### EXAMPLE 7

### Comparison of MOPS Comprising Gel to Standard Gel

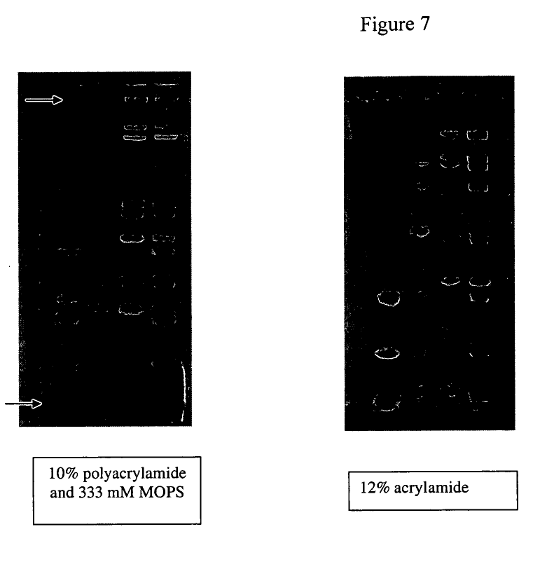

FIG. 7 shows a 10% polyacrlyamide gel comprising 333 mM MOPS to a standard 12% polyacrylamide gel. The gels were prepared using standard techniques as in the other examples. A protein sample containing the proteins shown below in Table 3 was loaded onto the gels and electrophoresis was performed. The gels were stained with Amersco Ultra-Coomassie Stain and destained. The MOPS gel shows that the full range of proteins was resolved without the need for gradient gels from 212,000 to 3,500 Daltons as shown in FIG. 7. The standard provided satisfactory separation of proteins from 212,000 to 14,000 Daltons only and with less clarity.

TABLE 3

| Protein | MW (Daltons) |
|---|---|
| Myosin | 212000 |
| Beta-Galactosidase | 116000 |
| Phosphorylase-B | 97400 |
| Albumin | 66200 |
| Ovalbumin | 40000 |
| Aldolase | 38000 |
| Carbonic Anhydrase | 31000 |
| TriosePhos.Isomerase | 26600 |
| Trypsin Inhibitor | 21000 |
| Myoglobin | 17000 |
| Lysozyme | 14400 |
| α-lactalbumin | 14200 |
| Aprotinin | 6500 |
| Insulin B-Oxidized | 3500 |

### EXAMPLE 8

### Comparison of 333mM MOPS Comprising Gel to 50 mM MOPS Comprising Gel

FIG. 8 shows the results of electrophoresis conducted on DNA micro markers and PCR DNA markers conducted on two 6% acrylamide gels. The gels were prepared using standard techniques as in the other examples. One of the gels comprised 333mM MOPS and the other gel comprised 50 mM MOPS, as shown in FIG. 8. The list of markers used is shown below in Table 4. The electrophoresis was conducted under identical conditions except for the MOPS concentration and no SDS.

TABLE 4

| Lanes 1 & 3 - DNA Micro Markers | Lanes 2 & 4 - PCR DNA Markers |
|---|---|
| (Size in Base Pairs) | (Size in Base Pairs) |
| 587 | 2000 |
| 458 | 1500 |
| 434 | 1000 |
| 298 | 900 |
| 267 | 750 |
| 174 | 500 |
| 102 | 450 |
| 80 | 300 |
| | 150 |
| | 50 |

A comparison of the two gels shows that increasing the concentration of MOPS decreases the relative mobility of DNA fragments. A similar change in mobility is expected for nucleic acids.

### EXAMPLE 9

### Polyacrylamide Gel Comprising MOPSO and POPSO

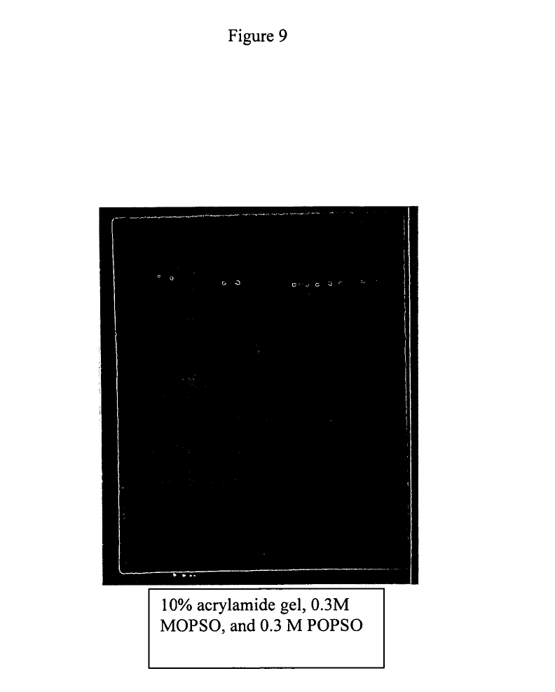

FIG. 9 shows the results of electrophoresis conducted on protein samples using a 10% polyacrylamide gel comprising 0.3 M of MOPSO and 0.3 M of POPSO. The gel was prepared using standard techniques as in the other examples. The proteins run on the gel were molecular weight standards with the molecular weights show in Table 5.

TABLE 5

| Protein | MW (Daltons) |
|---|---|
| Myosin | 212000 |
| Beta-Galactosidase | 116000 |
| Phosphorylase-B | 97400 |
| Albumin | 66200 |
| Ovalbumin | 40000 |
| Aldolase | 38000 |
| Carbonic Anhydrase | 31000 |
| Trypsin Inhibitor | 21000 |
| Lysozyme | 14400 |

An analysis of the results shown in FIG. 9 indicated that protein migration for the MOPSO/POPSO gel was even slower than in an equivalent gel with 0.667 M MOPS rather than MOPSO/POPSO. Thus, FIG. 9 demonstrates that MOPSO and POPSO can be used as well as MOPS.

### EXAMPLE 10

### Electrophoresis Using Agarose Gel Comprising MOPS

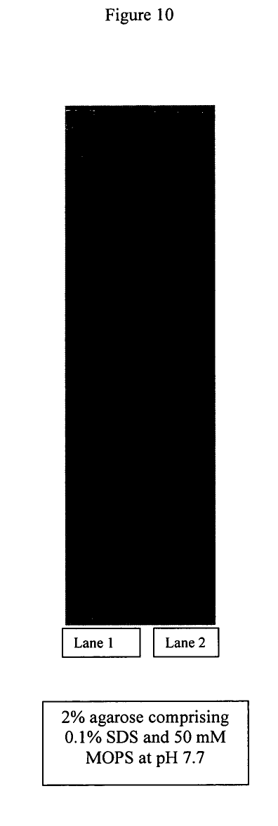

FIG. 10 shows migration of protein molecular weight markers and cross-linked myosin on a 2% agarose gel comprising 0.1% SDS and 50 mM MOPS at pH 7.7. The gel was prepared using standard techniques as in the other examples. Lane 1 contains the same protein markers listed above in Table 5, and lane 2 contains multimers of cross-linked myosin. The gel was run under standard conditions as in the other examples.

The results indicate fine resolution of both the protein markers and the cross-linked myosin protein sample. It is obvious that the agarose gels shown in the above example can resolve all the protein markers anywhere from 200-14.4 kDa (lane 1). In addition, it can also resolve proteins as high as 3,200 kDa (lane 2) or even higher. Such a high and wide resolution makes this novel tool quite suitable for numerous proteomics based applications. Convenience, ease of use, safe to handle, superior resolution, high throughput capability and cost effectiveness are the immediate benefits for agarose-based protein SDS gel electrophoresis.

While preferred embodiments have been illustrated and described, it should be understood that changes and modifications can be made therein in accordance with ordinary skill in the art without departing from the invention in its broader aspects as defined herein.

What is claimed:

1. An electrophoresis gel composition comprising:
a polymer;
at least 25 mM of at least one compound of Formula I: 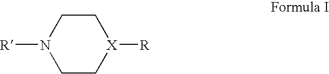
wherein R′ is a C₁-C₆ alkyl substituted with SO₃H and optionally substituted with OH; if X=0, R is a pair of electrons;
and if X=N, R is R′ and salts and solvates thereof; and
a surfactant;
wherein the gel is substantially free of formaldehyde.

2. The composition of claim 1, wherein the polymer is polyacrylamide.

3. The composition of claim 1, wherein the polymer is agarose.

4. The composition of claim 1, wherein the compound of Formula I is selected from the group consisting of MOPS, MOPSO, PIPES, and POPSO.

5. The composition of claim 1, wherein the compound of Formula I is MOPS.

6. The composition of claim 5, wherein the composition comprises at least 100 mM MOPS.

7. The composition of claim 5, wherein the composition comprises at least 300 mM MOPS.

8. The composition of claim 5, wherein the MOPS is present in free acid form.

9. The composition of claim 1, wherein the surfactant is SDS.

10. The composition of claim 9, wherein the SDS is present in a concentration of at least 0.2%.

11. The composition of claim 9, wherein the SDS is present in a concentration of at least 0.4%.

12. The composition of claim 9, wherein the SDS is present in a concentration of at least 0.6%.

13. The composition of claim 1, wherein the composition has a pH from between 6 to 8.

14. A pre-mixed solution for forming a gel comprising:
a compound that can be polymerized to form an electrophoresis gel; and
at least 25 mM of at least one compound of Formula I: 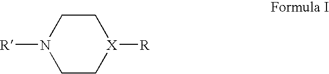
wherein R′ is a C₁-C₆ alkyl substituted with SO₃H and optionally substituted with OH; if X=0, R is a pair of electrons; and if X=N, R is R′and solvates thereof
wherein the gel is substantially free of formaldehyde.

15. The pre-mixed solution of claim 14, wherein the polymer is polyacrylamide.

16. The pre-mixed solution of claim 14, wherein the polymer is agarose.

17. The pre-mixed solution of claim 14, wherein the compound of Formula I is selected from the group consisting of MOPS, MOPSO, PIPES, and POPSO.

18. The pre-mixed solution of claim 14, wherein the compound of Formula I is MOPS.

19. The pre-mixed solution of claim 18, wherein the composition comprises at least 100 mM MOPS.

20. The pre-mixed solution of claim 18, wherein the composition comprises at least 300 mM MOPS.

21. The pre-mixed solution of claim 18, wherein the MOPS is present in free acid form.

22. The pre-mixed solution of claim 18, further comprising a surfactant.

23. The pre-mixed solution of claim 22, wherein the surfactant is SDS.

24. The pre-mixed solution of claim 22, wherein the SDS is present in a concentration of at least 0.2%.

25. The pre-mixed solution of claim 22, wherein the SDS is present in a concentration of at least 0.4%.

26. The pre-mixed solution of claim 22, wherein the SDS is present in a concentration of at least 0.6%.

27. The pre-mixed solution of claim 18, wherein the composition has a pH from between 6 to 8.

28. A method of separating proteins or nucleic acids using electrophoresis comprising:
providing an electrophoresis gel comprising a polymer and at least 25 mM of at least one compound of Formula I: 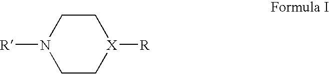
wherein R′ is a C₁-C₆ alkyl substituted with SO₃H and optionally substituted with OH; if X=0, R is a pair of electrons;
and if X=N, R is R′ and salts and solvates thereof; and
separating proteins or nucleic acids placed on the gel using electrophoresis.

29. The method of claim 28, wherein the polymer is polyacrylamide.

30. The method of claim 28, wherein the polymer is agarose.

31. The method of claim 28, wherein the compound of Formula I is selected from the group consisting of MOPS, MOPSO, PIPES, and POPSO.

32. The method of claim 28, wherein the compound of Formula I is MOPS.

33. The composition of claim 32, wherein the composition comprises at least 100 mM MOPS.

34. The composition of claim 32, wherein the composition comprises at least 300 mM MOPS.

35. The composition of claim 32, wherein the MOPS is present in free acid form.

36. The method of claim 28, wherein the gel further comprises a surfactant.

37. The method of claim 36, wherein the surfactant is SDS.

38. The method of claim 36, wherein the SDS is present in a concentration of at least 0.2%.

39. The method of claim 36, wherein the SDS is present in a concentration of at least 0.4%.

40. The method of claim 36, wherein the SDS is present in a concentration of at least 0.6%.

41. The method of claim 28, wherein the gel has a pH from between 6 to 8.4.

42. The method of claim 28, wherein the electrophoresis is performed using a running buffer comprising at least one compound of Formula I.

43. The method of claim 28, wherein the electrophoresis is performed without using a stacking gel.

44. A kit for protein or nucleic acid electrophoresis comprising an electrophoresis gel comprising at least 25 mM of at least one compound of Formula I: 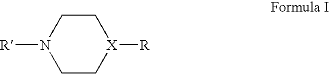
wherein R′ is a C₁-C₆ alkyl substituted with SO₃H and optionally substituted with OH;
if X=0, R is a pair of electrons; and if X=N, R is R′ and salts and solvates thereof.

45. The kit of claim 44, wherein the gel is polyacrylamide or agarose.

46. The kit of claim 44, wherein the compound of Formula I is MOPS.

47. The kit of claim 46, wherein the MOPS is present in a concentration of at least 300 mM.

48. The kit of claim 44, wherein the gel further comprises a surfactant.

49. A kit for protein or nucleic acid electrophoresis comprising a pre-mixed solution comprising a compound that can be polymerized to form an electrophoresis gel and at least 25 mM of at least one compound of Formula I: 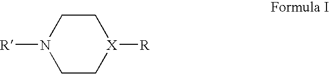
wherein R′ is a C₁-C₆ alkyl substituted with SO₃H and optionally substituted with OH;
if X=0, R is a pair of electrons; and if X=N, R is R′ and salts and solvates thereof.

50. The kit of claim 49, wherein the compound that can be polymerized to form an electrophoresis gel is acrylamide or agarose.

51. The kit of claim 49, wherein the compound of Formula I is MOPS.

52. The kit of claim 51, wherein the MOPS is present in a concentration of at least 300 mM.

53. The kit of claim 49, wherein the gel further comprises a surfactant.
